(19) United States
(12) Patent Application Publication
(10) Pub. No.: US 2026/0177347 A1
(43) Pub. Date: Jun. 25, 2026

(54) BALANCED PNEUMATIC REGULATOR

(71) Applicant: KORE OUTDOOR (US) INC., Fort Wayne, IN (US)

(72) Inventor: Danial S. JONES, Fort Wayne, IN (US)

(73) Assignee: KORE OUTDOOR (US) INC., Fort Wayne, IN (US)

(21) Appl. No.: 19/126,440

(22) PCT Filed: Nov. 6, 2023
(86) PCT No.: PCT/US2023/078810

§ 371 Date: May 1, 2025

Related U.S. Application Data
(60) Provisional application No. 63/422,560, filed on Nov. 4, 2022.

(51) Int. Cl. F41B 11/62; B60T 8/40; B60T 13/57; B60T 13/575; F41B 11/721

(52) U.S. Cl. CPC F41B 11/62; B60T 8/4031; B60T 13/57; B60T 13/575; F41B 11/721

(57) ABSTRACT

A balanced pneumatic regulator includes a body, an inlet seat element, a piston, and a piston plunger. The body includes a central axis extending through the body. The inlet seat element is fixedly positioned within the body, and the inlet seat element is fluidly coupled to a fluid inlet. The piston is positioned within the body downstream of the inlet seat element. The piston is configured 2024/098057 to translate axially along the central axis of the body. The piston includes an internal pressure chamber. The piston plunger is positioned least partially within the internal pressure chamber. During translation of the piston, a pressure on a downstream end of the piston is at least partially equalized by the pressure within the internal pressure chamber of the piston, which is supplied by fluid pressure from the fluid inlet to the piston plunger.

### CROSS REFERENCE TO RELATED APPLICATIONS

This application claims the benefit of U.S. Provisional Application No. 63/422,560 filed on Nov. 4, 2022, which is incorporated by reference as if fully set forth herein.

### FIELD OF INVENTION

The present disclosure relates to a fluid regulator, and more particularly, to a balanced pneumatic regulator.

### BACKGROUND

A pneumatic regulator is a component in a pneumatic system that is configured to maintain the output pressure of the gas expelling from the pneumatic regulator at a pre-set level. In some examples, a pneumatic regulator is utilized to reduce an input gas pressure to a lower pressure before the gas expels from the pneumatic regulator to be utilized later in the pneumatic system. In one specific example, a pneumatic regulator can be used for a pneumatic projectile launching device to reduce the gas pressure of the gas flowing from a high-pressure storage device, such as a compressed gas storage tank, to the pneumatic projectile launching device. In such an example, as the pressure within the high-pressure storage device swings from max pressure to the regulated output pressure, the force required to close and seal the pneumatic regulator seat can become inconsistent, which can lead to pressure irregularities and other issues.

Accordingly, there is a need for a balanced pneumatic regulator that reduces pressure fluctuations and the other issues associated with previous pneumatic regulators as the pressure within the high-pressure storage device approaches the regulated output pressure.

### SUMMARY

In one aspect, the present disclosure is directed to a balanced pneumatic regulator for pneumatic projectile launching devices. The balanced pneumatic regulator includes a body including a central axis that extends through the body. An inlet seat element within the body, the inlet seat element is fluidly coupled to a fluid inlet. A piston positioned within the body downstream of the inlet seat element, the piston being configured to translate axially along the central axis within the body between first and second axial positions. The piston includes an upstream end with a seat element that is adapted to seal against the inlet seat element in the first axial position. A passageway located within the seat element that extends to an internal pressure chamber. At least one channel that extends between the upstream end of the piston and a downstream end of the piston. The downstream end of the piston has a larger effective surface area than the upstream end of the piston. The at least one channel is located in an area outside of the seat element. A piston plunger extends at least partially within a hollow interior of the piston and extends at least partially outside the piston. The piston plunger seals the internal pressure chamber, and the piston is axially movable relative to the piston plunger. A spring biases the piston toward the second axial position. A regulated-pressure fluid outlet is positioned downstream of the piston. Upon a force of the spring exceeding a force generated by a fluid pressure at the downstream end of the piston, the piston is configured to translate axially toward the second axial position opening the at least one channel in the piston such that fluid from the fluid inlet travels toward the regulated-pressure fluid outlet. Further, a pressure on the downstream end of the piston is at least partially equalized by a pressure on the piston plunger within the internal pressure chamber of the piston.

In one embodiment, the body includes externals walls defining an internal cavity within the body. The inlet seat element is fixedly positioned within the internal cavity of the body. The piston is slidably positioned within the internal cavity of the body.

In one embodiment, when the piston is in the second axial position and upon a downstream article opening the regulated-pressure fluid outlet, a low-pressure zone is created on the downstream end of the piston and a fluid flowing from the fluid inlet produces a force within the internal pressure chamber to bias the piston toward the first axial position.

In one embodiment, an axial cross-sectional area of the seat element is approximately equal to an axial cross-sectional area of the piston plunger, with respect to the central axis.

In one embodiment, an axial cross-sectional area of the seat element is between 75% and 125% of an axial cross-sectional area of the piston plunger, with respect to the central axis.

In one embodiment, upon movement of the piston toward the second axial position, a pressure received from the fluid inlet is transmitted to the downstream end of the piston through the at least one channel until a pressure acting on the downstream end of the piston is sufficient to overcome the force of the spring and a force produced by the fluid inlet, biasing the piston back to the first axial position and sealing the seat element of the piston against the inlet seat element.

Additionally, the internal pressure chamber is fluidly coupled to the downstream end of the piston when the seat element of the piston is disengaged from the inlet seat element.

Additionally, the internal pressure chamber is fluidly coupled to the downstream end of the piston through the at least one channel extending between the upstream end of the piston and the downstream end of the piston.

Additionally, the internal pressure chamber is fluidly isolated from the downstream end of the piston when the seat element of the piston is engaged with the inlet seat element.

In one embodiment, the internal pressure chamber extends from the inlet seat element of the piston to an end of the piston plunger.

In one embodiment, a diameter of the passageway of the piston is equal to or smaller than a diameter of a conduit extending through the inlet seat element.

In one embodiment, the inlet seat element is fixedly positioned between a shoulder of the body and a threaded insert, such that an outer surface of the inlet seat element abuts the shoulder of the body, and the threaded insert forces the inlet seat element against the shoulder.

In one embodiment, the inlet seat element includes a conduit extending through the inlet seat element from an upstream end of the inlet seat element to a downstream end of the inlet seat element.

Additionally, the conduit of the inlet seat element fluidly couples the fluid inlet to the internal pressure chamber of the piston.

In one embodiment, the spring is positioned within the body, and wherein the spring is axially aligned with and surrounds at least a portion of the piston.

Preferably, the spring comprises a plurality of disc springs.

Additionally, the spring is configured to induce a force on the piston to cause the piston to translate away from the fluid inlet and towards the regulated-pressure fluid outlet, opening connection from the fluid inlet to the regulated-pressure fluid outlet through the at least one channel.

In one embodiment, when the piston is in the second axial position, a fluid flowing from the fluid inlet produces a force that causes the piston plunger to bias the piston toward the first axial position to at least partially offset a force acting upon the seat element of the piston.

In one embodiment, at least one seal positioned between the piston and the body; and at least one seal positioned between a piston plunger and the piston.

In one embodiment, the balanced pneumatic regulator is configured for use with a pneumatic projectile launching device.

In another aspect, the present disclosure is directed to a balanced pneumatic regulator for pneumatic projectile launching devices. The balanced pneumatic regulator includes a body including a central axis that extends through the body. An inlet seat element within the body, the inlet seat element is fluidly coupled to a fluid inlet through a conduit. A piston positioned within the body downstream of the inlet seat element, the piston being configured to translate axially along the central axis within the body between first and second axial positions. The piston including an upstream end with a seat element that is adapted to seal against the inlet seat element in the first axial position. A passageway located within the seat element that extends to an internal pressure chamber. At least one channel that extends between the upstream end of the piston and a downstream end of the piston. The at least one channel is located in an area outside of the seat element. A piston plunger extending axially away from a downstream end of the piston, the piston plunger including a pressure passage extending through the piston plunger and fluidly coupling the passageway to a pressure chamber separate from the piston. A spring biases the piston toward the second axial position. A regulated-pressure fluid outlet is positioned downstream of the piston. Upon a force of the spring exceeding a force generated by a fluid pressure at the downstream end of the piston, the piston is configured to translate axially toward the second axial position opening the at least one channel in the piston such that fluid from the fluid inlet travels toward the regulated-pressure fluid outlet. Further, a pressure on the upstream end of the piston is at least partially equalized by a pressure on a downstream end of the piston plunger within the pressure chamber.

### BRIEF DESCRIPTION OF THE DRAWING(S)

The foregoing Summary and the following Detailed Description will be better understood when read in conjunction with the appended drawings, which illustrate a preferred embodiment of the disclosure. In the drawings:

FIG. 1 is an isometric view of a balanced pneumatic regulator;

FIG. 2 is a top view of the balanced pneumatic regulator of FIG. 1;

FIG. 3A is a cross-sectional view taken along section 3-3 of FIG. 2 illustrating the balanced pneumatic regulator in a first position;

FIG. 3B is a cross-sectional view taken along section 3-3 of FIG. 2 illustrating the balanced pneumatic regulator in a second position; and

FIG. 4 is a close-up, partial cross-sectional view of a second embodiment of the balanced pneumatic regulator.

### DETAILED DESCRIPTION OF THE PREFERRED EMBODIMENT(S)

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terms “generally” and “approximately” are to be construed as within 10% of a stated value or ratio. The terminology includes the words specifically noted above, derivatives thereof, and words of similar import.

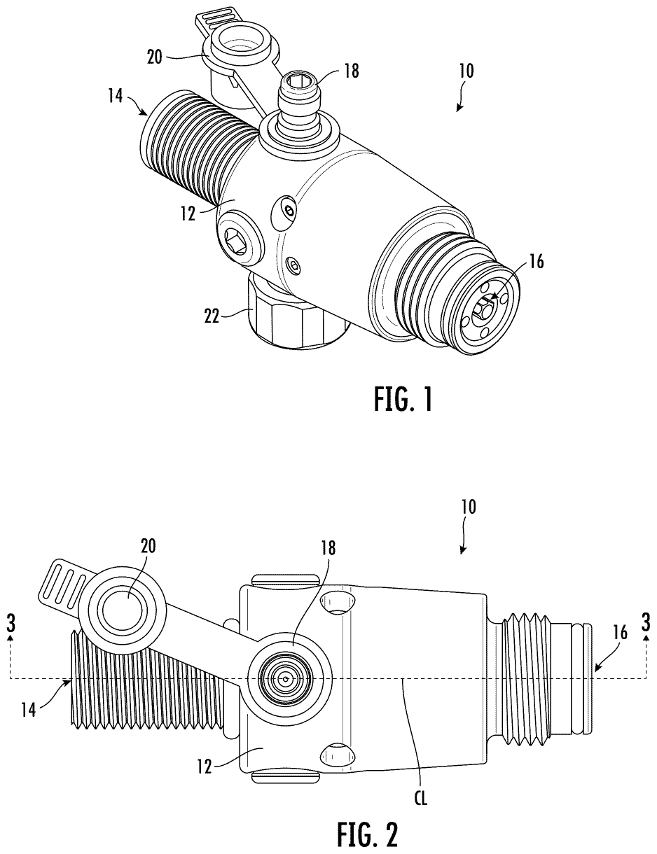

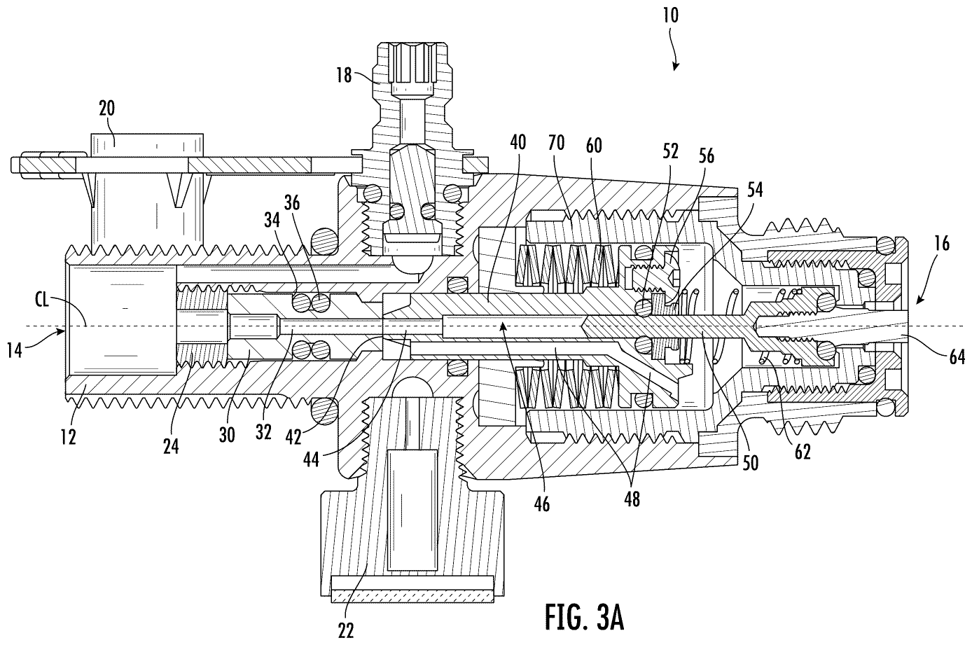

FIG. 1 is an isometric view of a balanced pneumatic regulator 10. FIG. 2 is a top view of the balanced pneumatic regulator 10. FIGS. 1-2 will be discussed together. Further, the balanced pneumatic regulator 10 will hereinafter be referred to as the “regulator 10”, but it is to be understood that the regulator 10 and the balanced pneumatic regulator 10 are referring to the same device/assembly. The regulator 10 is a device configured to maintain the output pressure of the gas expelling from the regulator 10. Further, the regulator 10 is configured to reduce the gas pressure of the input gas received by the regulator 10 to a lower pressure before the gas expels from the regulator 10.

In one embodiment, the regulator 10 can receive input gas, for example, ranging in pressure up to 6,000 psi, or possibly beyond, and may be in a range from about 4,500 psi to about 6,000 psi, while the gas expelling from the regulator 10 can have a pressure, for example, ranging between about 150 psi and about 1,250 psi. In some embodiments, the regulator 10 can be used for a pneumatic projectile launching device assembly, such as a paintball marker, to reduce the pressure of the gas flowing from a high-pressure storage device to the pneumatic projectile launching device. Further, the regulator 10 can be used with a variety of different gases, such as high-pressure air (HPA), among other high-pressure gases not specifically listed.

The regulator 10 includes a body 12 which is the main structural component of the regulator 10 in which other components and features of the regulator 10 are oriented relative to. The body 12 can, for example, be generally cylindrical in shape and a central axis CL extends centrally through the body 12. A fluid inlet 14 is positioned at an upstream end of the body 12 and a regulated-pressure fluid outlet 16 is positioned at a downstream end of the body 12. It is to be understood that the terms “upstream” and “downstream” refer to the direction in which gases or other fluids flow through the regulator 10. For example, fluid flows from upstream to downstream and therefore the gases flowing through the regulator 10 enter the regulator 10 at the fluid inlet 14 and flow downstream through the regulator 10 to the regulated-pressure fluid outlet 16.

The fluid inlet 14 is positioned at an upstream end of the regulator 10 and the fluid inlet 14 is configured to receive high-pressure gases from a high-pressure storage device (not shown). In some embodiments, as shown, the body 12 can include an exterior inlet feature adjacent the fluid inlet 14 which can be used to couple a high-pressure storage device, such as a tank or compressor, to the regulator 10 through a mating feature of the high-pressure storage device. In other embodiments, a high-pressure storage device can be coupled to the regulator 10 through other known techniques, such as hoses, manifolds, gas supplies, and the like. The fluid inlet 14 is the feature and location of the regulator 10 in which high-pressure gases enter the regulator 10 before the pressure of the gas is reduced and then the gas could be stored and or expelled from the regulator 10.

In the illustrated embodiment, the regulated-pressure fluid outlet 16 is positioned at a downstream end of the regulator 10 from the fluid inlet 14. The regulated-pressure fluid outlet 16 is configured to expel gases from the regulator 10 at a regulated pressure, which is set to a lower pressure than the pressure of the gases entering the regulator 10, at least until the pressure of the gas in the high-pressure storage device drops down to the regulated pressure that is set. In some embodiments, as shown, the body 12 can include exterior threads adjacent the regulated-pressure fluid outlet 16 which can be used to couple the regulator 10 to an ASA Adapter (Air Source Adapter), paintball marker, or other pneumatic projectile launching devices. In other embodiments, the regulator 10 can be fluidly coupled to a paintball marker or other pneumatic projectile launching device through other known techniques. The regulated-pressure fluid outlet 16 is the feature and location of the regulator 10 in which the regulated pressure gases exit and expel from the regulator 10 for use by a paintball marker or other pneumatic projectile launching device. It is to be understood that the terms “high-pressure” and “low-pressure” are relative terms, such that it is to be understood that the gases expelling from the regulated-pressure fluid outlet 16 are generally at a regulated lower pressure than the gases entering the fluid inlet 14, at least until the pressure of the gas in the high-pressure storage device drop down to the regulated pressure that is set.

The regulator 10 preferably also includes a refill fitting 18, a cover 20, and a pressure gauge 22. The refill fitting 18 is positioned and coupled to an external surface of the body 12 of the regulator 10. The refill fitting 18 extends partially outside of the body 12 and the refill fitting 18 extends partially within the body 12. The refill fitting 18 is configured to provide a location in which pressurized gases can be filled back into the high-pressure storage device. The refill fitting 18 can be any high-pressure pneumatic fitting that is configured to allow pressurized gases to flow into the regulator 10 and into the high-pressure storage device. A removable cover 20 is optionally positioned adjacent the refill fitting 18 and the cover 20 is configured to surround the refill fitting 18 and prevent dust or other debris from entering the refill fitting 18. As such, when the refill fitting 18 is not being used, the cover 20 can be utilized to cover and protect the refill fitting 18 from foreign debris. In the illustrated embodiment, the pressure gauge 22 is optionally positioned and coupled to an external surface of the body 12. The pressure gauge 22 is configured to allow a user to easily identify the gas pressure within the regulator 10 and/or the high-pressure storage device. The pressure gauge 22 can be any device that allows easy identification of gas pressure within the regulator 10 and/or the high-pressure storage device. In other non-illustrated embodiments, the pressure gauge 22 may not be included in the regulator 10.

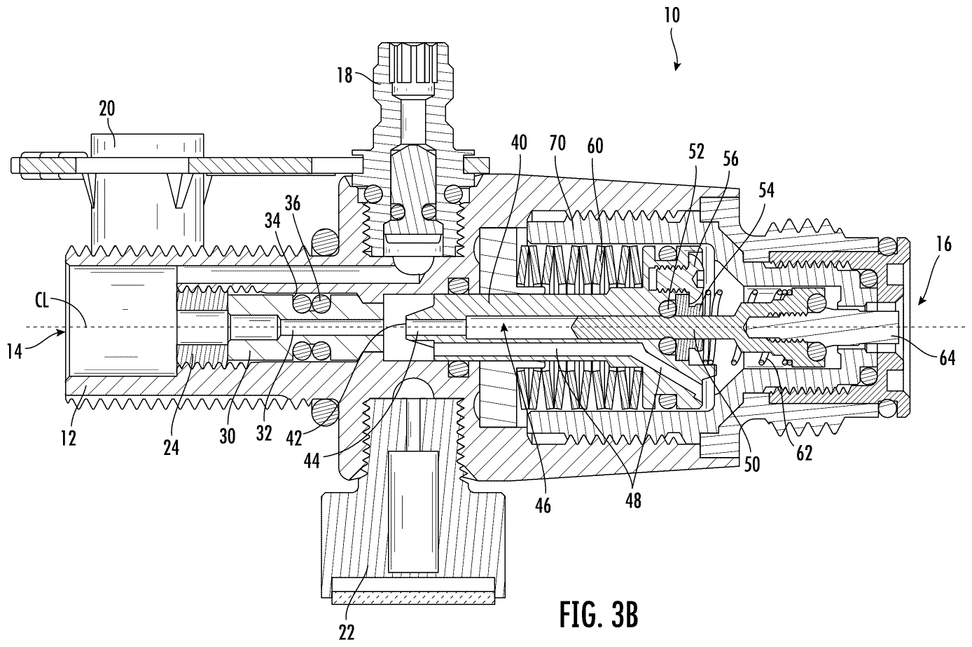

FIG. 3A is a cross-sectional view taken along section 3-3 of FIG. 2 illustrating the regulator 10 in a first position. FIG. 3B is a cross-sectional view taken along section 3-3 of FIG. 2 illustrating the regulator 10 in a second position. More specifically, FIG. 3A illustrates a piston 40 positioned in a first axial position and FIG. 3B illustrates the piston 40 in a second axial position. FIGS. 3A-3B will be discussed together.

As shown best in FIGS. 3A-3B, the regulator 10 includes the body 12, the fluid inlet 14, a threaded insert 24, an inlet seat element 30, a piston 40, a piston plunger 50, a spring 60, a housing 70, and the regulated-pressure fluid outlet 16. The body 12 includes the central axis CL extending through a center of the body 12, and the body 12 includes external walls defining an internal cavity within the body 12. An inlet seat element 30 is positioned within the internal cavity of the body 12 and the piston 40 is slidably positioned within the internal cavity of the body 12, discussed further below. The piston 40 includes a piston seat element 42 that is adapted to seal against the inlet seat element 30 in a first axial position of the piston 40, as discussed below. In the illustrated embodiment, the inlet seat element 30 can be an inlet seat, and the piston seat element 42 can be a seat face that is adapted to seal against the inlet seat. Alternatively, the inlet seat element 30 could be a seat face, and the piston seat element could be a mating seat.

In the embodiment shown, inlet seat element 30 is fixedly positioned within the body 12 adjacent the fluid inlet 14 and axially aligned with the central axis CL of the regulator 10. The inlet seat element 30 is fluidly coupled to the fluid inlet 14 such that the inlet seat element 30 receives a high-pressure gas from the fluid inlet 14. In some embodiments, the inlet seat element 30 is fixedly positioned within the body 12 between a shoulder of the body 12 and the threaded insert 24, such that an outer surface of the inlet seat element 30 abuts the shoulder of the body 12. In the embodiment shown, the threaded insert 24 forces the inlet seat element 30 against the shoulder to secure the inlet seat element 30 within the body 12. In other embodiments, the inlet seat element 30 can be secured within the body 12 using other techniques known to those skilled in the art.

The inlet seat element 30 can include a conduit 32 extending through the inlet seat element 30 from an upstream end of the inlet seat element 30 to a downstream end of the inlet seat element 30. The conduit 32 is configured to provide a flow path through the inlet seat element 30 in which high-pressure gas can flow downstream into the regulator 10. In the embodiment shown, the inlet seat element 30 includes a circumferential groove 34 extending into the inlet seat element 30 from an outer surface of the inlet seat element 30 towards the central axis CL. The circumferential groove 34 is configured to accept at least one seal 36 such that the at least one seal 36 is positioned between the body 12 and the inlet seat element 30. The at least one seal 36 is configured to prevent a high-pressure gas from flowing between the inlet seat element 30 and the body 12. In other embodiments, the at least one seal 36 may not be included and an interference fit or other sealing mechanism can be used to prevent a gas from flowing between the inlet seat element 30 and the body 12.

This piston 40 is positioned within the body 12 downstream of the inlet seat element 30 and upstream of the regulated-pressure fluid outlet 16, and the piston 40 is axially aligned with the central axis CL. The piston 40 is configured to translate axially along the central axis CL within the body 12 between a first axial position and a second axial position, discussed further below. The piston 40 has an upstream end with a first effective surface area and a downstream end with a second effective surface area. In the embodiment shown, the downstream end of the piston 40 has a larger effective surface area than the upstream end of the piston 40. The piston 40 includes the seat element 42, a passageway 44, an internal pressure chamber 46, and at least one channel 48. The seat element 42 in the illustrated embodiment is a seat face and is positioned at an upstream distal end of the piston 40 and the seat element 42 is configured to abut and seal against the inlet seat element 30 when the piston 40 is in the first axial position. In the embodiment shown, the seat element 42 is a flat annular surface arranged normal to an axial direction along the central-axis CL. In other embodiments, the seat element 42 can have any geometric or non-geometric shape, such as an angled or curved surface.

The passageway 44 extends through the seat element 42 of the piston 40 and the passageway 44 is preferably axially aligned with the central axis CL of the regulator 10. The passageway 44 extends from the distal upstream end of the piston 40 to the internal pressure chamber 46. The passageway 44 is a conduit, channel, or the like that allows a high-pressure gas to flow from the conduit 32 of the inlet seat element 30 to the internal pressure chamber 46. As such, the conduit 32 of the inlet seat element 30 and the passageway 44 of the piston 40 fluidly couple the fluid inlet 14 to the internal pressure chamber 46 of the piston 40. In the illustrated embodiment, the passageway 44 has a diameter equal to a diameter of the conduit 32 extending through inlet seat element 30. In some embodiments, the passageway 44 can have a diameter smaller than a diameter of the conduit 32 of the inlet seat element 30. In other embodiments, the passageway 44 can have a diameter larger than a diameter of the conduit 32 of inlet seat element 30. Further, in one embodiment, the conduit 32 can have a constant diameter extending through the inlet seat element 30. In other embodiments, as shown, the conduit 32 can include a first portion having a first diameter and a second portion having a second diameter, with the first diameter differing from the second diameter.

The internal pressure chamber 46 is positioned within the piston 40 and the internal pressure chamber 46 is preferably axially aligned with the central axis CL of the regulator 10. The internal pressure chamber 46 extends from a downstream end of the passageway 44 to a downstream end of the piston 40. The internal pressure chamber 46 can also be described as extending from the seat element 42 of the piston 40 to a distal end of the piston plunger 50 because the gas pressure within that region will be equal. The internal pressure chamber 46 is a conduit, channel, or the like into which a high-pressure gas flows from the passageway 44. In the embodiment shown, a diameter of the internal pressure chamber 46 is greater than a diameter of the passageway 44, creating a step or shoulder between the internal pressure chamber 46 and the passageway 44. In other embodiments, the internal pressure chamber 46 and the passageway 44 can have the same diameter, such that a single conduit, channel, or the like having a constant diameter extends from the seat element 42 of the piston 40 to a downstream end of the piston 40.

The piston 40 also includes at least one channel 48 extending between the upstream end of the piston 40 and a downstream end of the piston 40, fluidly coupling the upstream and downstream ends of the piston 40. The at least one channel 48 extends through the upstream end of the piston 40 in an area outside of the seat element 42. The downstream end of the at least one channel 48 extends through the downstream end of the piston 40 adjacent an outer edge or corner of the downstream end of the piston 40. In the embodiment shown, the at least one channel 48 includes a first portion radially offset and parallel with the central axis CL, and a second portion oriented nonparallel with the first portion and the central axis CL. The first and second portions of the at least one channel 48 are fluidly coupled, allowing a gas to flow from the upstream end of the piston 40 to the downstream end of the piston 40.

Further, in some embodiments, a seal is preferably positioned between an outer surface of the piston 40 and an inner surface of the body 12, or an internal wall of a housing 70 coupled to the end of the body 12, preventing a gas from flowing outside of the piston 40 and the body 12. In other embodiments, a seal may not be included and another sealing mechanism can be used to prevent a gas from flowing outside of the piston 40 and the body 12.

The piston plunger 50 is axially aligned with the central axis CL and the piston plunger 50 is positioned at least partially within the body 12 and at least partially within a housing 70 coupled to an end of the body 12. In some embodiments, the housing 70 can be coupled to the body 12 through a mating threaded attachment. Further, the housing 70 can at least partially surround the piston 40 and the piston plunger 50, among other components of the regulator 10. The piston plunger 50 is generally positioned between the piston 40 and the regulated-pressure fluid outlet 16. More specifically, in some embodiments, a first end of the piston plunger 50 extends at least partially within a hollow interior (the internal pressure chamber 46) of the piston 40 from the downstream end, and a second end of the piston plunger 50 extends at least partially outside of the piston 40 within the housing 70 and towards the regulated-pressure fluid outlet 16.

In the embodiment shown, the piston plunger 50 seals the internal pressure chamber 46 at the downstream end of the piston 40, preventing a gas from flowing through the internal pressure chamber 46 and out through the downstream end of the piston 40. In other embodiments, the piston plunger 50 could seal the internal pressure chamber 46 at the upstream end of the piston 40, to prevent a gas from flowing through the internal pressure chamber and out through the upstream end of the piston 40. The piston 40 is axially movable/translatable relative to the piston plunger 50 along the central axis CL. As shown in FIG. 3A, the piston 40 is arranged in the first axial position when the piston 40 is in the furthest direction towards the fluid inlet 14. As shown in FIG. 3B, the piston 40 is arranged in the second axial position when the piston 40 is positioned closer to the regulated-pressure fluid outlet 16, compared to the first axial position, discussed further below.

In some embodiments, as shown, a seal 52 is preferably positioned between the piston plunger 50 and the piston 40. The seal 52 can further aid in preventing a gas from flowing through the internal pressure chamber 46 and out through the downstream end of the piston 40. In the embodiment shown, the seal 52 is positioned within a groove or cutout within the downstream end of the piston 40 and a seal cover 54 can be positioned over the seal 52 to secure the seal 52 within the groove in the piston 40. In some embodiments, as shown, a fastener 56 radially offset from the central axis CL can be used to couple the seal cover 54 to the piston 40. In other embodiments, other fasteners or approaches can be used to secure the seal cover 54 to the piston 40. Further, in some embodiments, the seal cover 54 may not be included and the seal 52 can be secured within the piston 40 using standard approaches known by those skilled in the art.

A spring 60 is positioned within the body 12 and the spring 60 is axially aligned with the central axis CL and the piston 40. Further, the spring 60 surrounds at least a portion of the piston 40, and a first end of the spring 60 abuts and engages a downstream facing surface of the body 12 and a second end of the spring 60 abuts and engages an upstream facing surface of the downstream end of the piston 40. The spring 60 is configured to bias the piston 40 downstream towards the second axial position and the pressure-regulated fluid outlet 16. In the embodiment shown, the spring 60 includes a plurality of disc springs stacked on top of one another (i.e. a spring stack). In another embodiment, the spring 60 could be another type of spring or component capable of inducing a force on the piston 40 to cause the piston 40 to translate away from the fluid inlet 14 and towards the regulated-pressure fluid outlet 16, which is positioned downstream of the piston 40.

In some embodiments, as shown, a spring 62 can be positioned between the downstream end of the piston 40 and the housing 70 adjacent the regulated-pressure fluid outlet 16. The spring 62 is used in connection with a poppet 64 at the fluid outlet 16 to bias the poppet 64 to a closed position. The poppet 64 is opened against the force of the spring 62 when connecting a downstream device to the fluid outlet 16. In the illustrated embodiment, the piston plunger 50 is connected to the poppet 64. However, this is merely optional and the piston plunger 50 could be otherwise mounted to the body 12 or the piston 40.

Referring now to FIG. 3A in which the piston 40 is in the first axial position and the seat element 42 of the piston 40 is abutting and sealed against the inlet seat element 30. In operation, a high-pressure storage device or tank (not shown) is coupled to the fluid inlet 14 on the upstream end of the regulator 10. A high-pressure gas flows from the high-pressure storage device, through the fluid inlet 14, through a channel extending axially through the threaded insert 24, through the conduit 32 extending axially through the inlet seat element 30, through the passageway 44 of the piston 40, and into the internal pressure chamber 46. As such, the high-pressure storage device is fluidly coupled to the internal pressure chamber 46, providing high-pressure gas into the internal pressure chamber 46. Further, the internal pressure chamber 46 remains fluidly isolated from the downstream end of the piston 40, preventing fluid communication between the internal pressure chamber 46 and the downstream end the piston 40 until the piston 40 translates out of the first axial position. It is to be understood that the illustrated embodiment includes the fluid inlet 14 and the threaded insert 24, but in other embodiments the fluid inlet 14 and the threaded insert 24 may not be included and the inlet seat element 30 can be secured within the body 12 using other fastening arrangements.

When a downstream component/device is coupled to the regulated-pressure fluid outlet 16 and allows pressurized gas to expel out through the pressure-regulated fluid outlet 16, the pressure in the area on the downstream side of the piston 40 drops below a preset regulated pressure such that the actual pressure in this region times the downstream surface area of the piston is less than the force of the spring 60, such that the spring 60 forces the piston 40 into the second axial position, towards the regulated-pressure fluid outlet 16. In other words, upon a force of the spring 60 exceeding a force generated by a fluid pressure at the downstream end of the piston 40, the piston 40 is configured to translate axially toward the second axial position (FIG. 3B). In turn, this opens the at least one channel 48 such that fluid from the fluid inlet 14 travels toward the regulated-pressure fluid outlet 16, and a pressure on the downstream end of the piston 40 is increased.

Therefore, when the piston 40 is in the second axial position (FIG. 3B), the seat element 42 of the piston 40 is disengaged from the inlet seat element 30 and the internal pressure chamber 46 is fluidly coupled to the downstream end of the piston 40 through the at least one channel 48 extending between the upstream end of the piston 40 and the downstream end of the piston 40. This allows the high-pressure gas to flow from the high-pressure storage device to the downstream end of the piston 40, increasing a pressure in the zone or chamber between the downstream end of the piston 40 and the regulated-pressure fluid outlet 16 with the pressurized gas. Once this pressure reaches the regulated pressure such that the pressure in this zone or chamber times the downstream surface area of the piston 40 is greater than the force of the spring 60, the piston 40 moves back to the first axial position such that the seat element 42 seals against the inlet seat element 30.

During the time that the piston 40 is in the second axial position, the pressurized gas flowing from the fluid inlet 14 produces a force on the downstream end of the piston 40, causing the piston 40 to bias against the spring force towards the first axial position. Further, the force on the downstream end of the piston 40 is at least partially offset by a force produced by the high-pressure gas acting upon the seat element 42 of the piston 40 which varies as the pressure at the fluid inlet 14 decreases, for example as the pressure within a tank connected to the fluid inlet 14 drops through use, which affects the amount of force required to translate piston 40 back to the first axial position (FIG. 3A). This could affect the value of the regulated pressure at the fluid outlet 16.

In order to at least partially compensate for the varying inlet pressure, here an axial cross-sectional area of the piston plunger 50 is approximately equal to a surface area of seat element 42 on the piston 40 looking in the axial direction. Having the same or similar cross-sectional areas aids in the translation between the first axial position and the second axial position by reducing the amount of force required to translate the piston 40 back to the first axial position by balancing the pressure forces acting on the piston 40 from the fluid inlet 14. Here, the area of the piston plunger 50 does not act in translating the piston 40 toward the second axial position, and the pressure in the internal pressure chamber 46 (which is the same as the pressure that acts on the seat element 42 of the piston 40) acts to bias the piston 40 back toward the first axial position. This balances the forces acting on the piston 40 when it is in both the first axial position and the second axial position.

In some embodiments, a surface area of the seat element 42 (looking in an axial direction) is between 75% and 125% of a cross-sectional area of the piston plunger 50, taken normal to the central axis CL, to minimize the force required to translate the piston 40 back to the first axial position. In previous pneumatic regulators that use an internal fixed ratio piston, the force required to return the piston to the first axial position would decrease as the gas pressure within the high-pressure storage device or tank decreases. As such, this could increase the pressure at the fluid outlet, which could raise regulated pressure output to pressures that are sometimes substantially greater than the desired regulated pressure. This can negatively affect the performance of the connected downstream device.

The regulator 10 including equal or approximately equal cross-sectional areas between the piston plunger 50 and the seat element 42 aids in balancing the forces on the piston 40, ensuring the force required to translate the piston 40 back to the first axial position does not increase or decrease as the gas pressure within the high-pressure storage device or tank increases or decreases. In other words, the piston plunger 50 of regulator 10 balances the forces experienced by piston 40 regardless of the pressure supplied to regulator 10. In turn, the supply pressure from the high-pressure storage device does not affect or alter the force required to translate the piston 40 in either direction (to or away from the first axial position), resulting in a balanced pneumatic regulator. As such, the regulator 10 is an improved pneumatic regulator compared to previous pneumatic regulators used in pneumatic projectile launching devices.

After translating the piston 40 toward the second axial position, a pressure received from the fluid inlet 14 is transmitted to the downstream end of the piston 40 through the at least one channel 48 until a pressure acting on the downstream end of the piston 40 is sufficient to overcome the force of the spring 60 and a force produced by the fluid inlet 14 on the upstream end of the piston 40, moving the piston 40 back to the first axial position and sealing seat element 42 of the piston 40 against the inlet seat element 30. The piston 40 will remain in the first axial position, in a balanced configuration, until a downstream device allows gas to flow out through the regulated-pressure fluid outlet 16 and the pressure on the downstream end of the piston 40 drops below the regulated pressure, in effect forming a lower-pressure zone. At that time, the piston 40 will again translate to the second axial position, as discussed above.

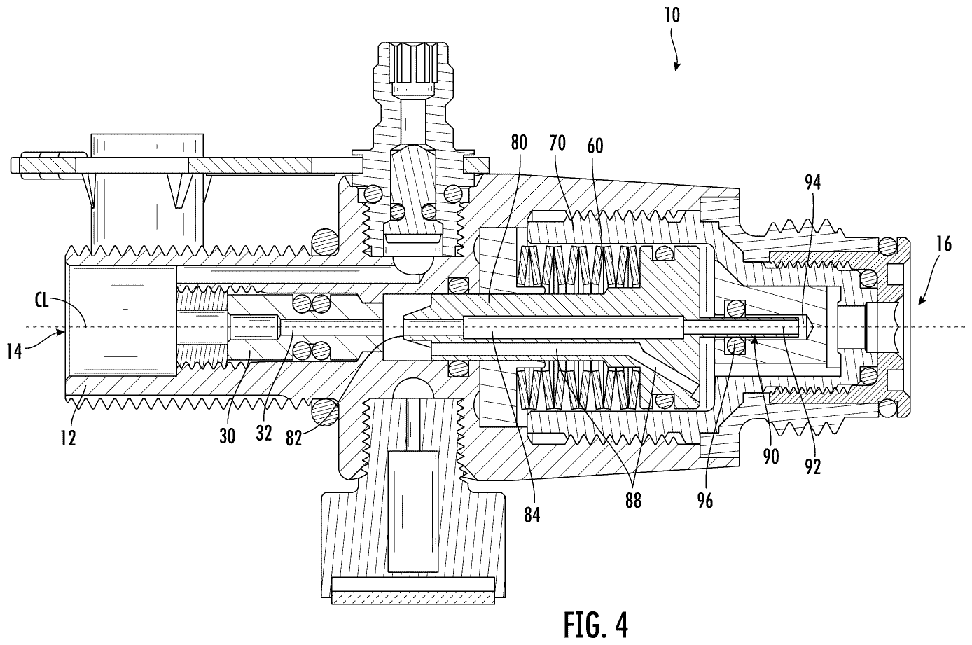

Referring to FIG. 4, a second embodiment of the regulator 10 is illustrated. Unless specifically noted, it is to be understood that the discussion regarding the regulator 10 shown in FIGS. 3A-3B equally applies to the second embodiment of the regulator 10 shown in FIG. 4. As such, the discussion regarding the specific components and functionality of the regulator 10 will not be repeated here. As shown in FIG. 4, the second embodiment of the regulator 10 includes a piston 80 including a piston seat element 82, a passageway 84, at least one channel 88, a piston plunger 90, a pressure passage 92, and a pressure chamber 94 downstream of the piston 80.

In the embodiment shown in FIG. 4, the piston plunger 90 is formed integral with the piston 80 such that the piston plunger 90 is formed as a single-piece construction with the piston 80. In this embodiment, the piston plunger 90 extends axially away from the downstream end of the piston 80. The piston plunger 90 includes the pressure passage 92 extending through the piston plunger 90 and fluidly coupling the passageway 84 to the pressure chamber 94. The piston plunger 90 is slidable as the piston 80 moves in the pressure chamber 94, and remains sealed via a seal 96. As such, the passageway 84 and the pressure passage 92 form a flow path for high-pressure gas to flow from the inlet 14 to the pressure chamber 94. In the embodiment illustrated in FIG. 4, the piston 80 including the piston plunger 90 is configured to balance the forces that act on the piston seat element 82 as well as the upstream end of the piston 80 when the piston 80 is in the second axial position, as shown, balancing the variable gas pressure from the fluid inlet 14 within the regulator 10 during operation.

More specifically, a pressure on the upstream end of the piston 80 is at least in part balanced by a pressure on a downstream end of the piston plunger 90 within the pressure chamber 94, balancing the forces on the piston 80 and aiding in translation between the second axial position and the first axial position. As such, the second embodiment of the regulator 10 including the piston 80 and the piston plunger 90 is configured to at least partially balance the gas pressures on the piston 80, such that the force produced by the gas pressure on the downstream end of the piston 80 only needs to overcome the force produced by the spring 60 to translate the piston 80 back to the first axial position, ensuring a more constant regulated gas pressure at the fluid outlet regardless of the declining gas pressure from the high-pressure storage device or tank.

The regulator 10 is a pneumatic regulator that is configured to balance the gas pressures on the piston 40 from the fluid inlet 14, such that the force produced by the gas pressure on the downstream end of the piston 40 only needs to overcome the force produced by the spring 60 to translate the piston 40 back to the first axial (closed) position. The regulator 10 prevents the issues of increasing the force required to translate the piston 40 back to the first axial position and the issue of increased output pressure of the regulator. Further, one skilled in the art will appreciate the many other advantages of the regulator 10, compared to previous pneumatic regulators, not specifically described.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

Regulator 10
Body 12
Fluid inlet 14
Fluid outlet 16
Refill fitting 18
Cover 20
Pressure gauge 22
Threaded insert 24
Inlet seat element 30
Conduit 32
Circumferential groove 34
Seal 36
Piston 40
Seat face element 42
Passageway 44
Internal pressure chamber 46
Channel 48
Piston plunger 50
Seal 52
Seal cover 54
Fastener 56
Spring 60
Spring 62
Housing 70
Piston 80
Piston seat element 82
Passageway 84
Channel 88
Piston plunger 90
Pressure passage 92
Pressure chamber 94
Seal 96
Central axis CL

What is claimed is:

1. A balanced pneumatic regulator comprising:
a body including a central axis that extends through the body;
an inlet seat element within the body, the inlet seat element is fluidly coupled to a fluid inlet;
a piston positioned within the body downstream of the inlet seat element, the piston being configured to translate axially along the central axis within the body between first and second axial positions, the piston including an upstream end with a seat element that is adapted to seal against the inlet seat element in the first axial position, a passageway located within the seat element that extends to an internal pressure chamber, and at least one channel that extends between the upstream end of the piston and a downstream end of the piston, the downstream end of the piston having a larger effective surface area than the upstream end of the piston, and the at least one channel is located in an area outside of the seat element;
a piston plunger extending at least partially within a hollow interior of the piston and extending at least partially outside the piston, the piston plunger sealing the internal pressure chamber, and the piston being axially movable relative to the piston plunger;
a spring that biases the piston toward the second axial position; and
a regulated-pressure fluid outlet positioned downstream of the piston;
wherein, upon a force of the spring exceeding a force generated by a fluid pressure at the downstream end of the piston, the piston is configured to translate axially toward the second axial position opening the at least one channel in the piston such that fluid from the fluid inlet travels toward the regulated-pressure fluid outlet, and a pressure on the downstream end of the piston is at least partially equalized by a pressure on the piston plunger within the internal pressure chamber of the piston.

2. The balanced pneumatic regulator of claim 1, wherein:
the body includes externals walls defining an internal cavity within the body;
the inlet seat element is fixedly positioned within the internal cavity of the body; and
the piston is slidably positioned within the internal cavity of the body.

3. The balanced pneumatic regulator of claim 1, wherein when the piston is in the second axial position and upon a downstream article opening the regulated-pressure fluid outlet, a low pressure zone is created on the downstream end of the piston and a fluid flowing from the fluid inlet produces a force within the internal pressure chamber to bias the piston toward the first axial position.

4. The balanced pneumatic regulator of claim 1, wherein an axial cross-sectional area of the seat element is approximately equal to an axial cross-sectional area of the piston plunger, with respect to the central axis.

5. The balanced pneumatic regulator of claim 1, wherein an axial cross-sectional area of the seat element is between 75% and 125% of an axial cross-sectional area of the piston plunger, with respect to the central axis.

6. The balanced pneumatic regulator of claim 1, wherein upon movement of the piston toward the second axial position, a pressure received from the fluid inlet is transmitted to the downstream end of the piston through the at least one channel until a pressure acting on the downstream end of the piston is sufficient to overcome the force of the spring and a force produced by the fluid inlet, biasing the piston back to the first axial position and sealing the seat element of the piston against the inlet seat element.

7. The balanced pneumatic regulator of claim 6, wherein the internal pressure chamber is fluidly coupled to the downstream end of the piston when the seat element of the piston is disengaged from the inlet seat element.

8. The balanced pneumatic regulator of claim 7, wherein the internal pressure chamber is fluidly coupled to the downstream end of the piston through the at least one channel extending between the upstream end of the piston and the downstream end of the piston.

9. The balanced pneumatic regulator of claim 6, wherein the internal pressure chamber is fluidly isolated from the downstream end of the piston when the seat element of the piston is engaged with the inlet seat element.

10. The balanced pneumatic regulator of claim 1, wherein the internal pressure chamber extends from the inlet seat element of the piston to an end of the piston plunger.

11. The balanced pneumatic regulator of claim 1, wherein a diameter of the passageway of the piston is equal to or smaller than a diameter of a conduit extending through the inlet seat element.

12. The balanced pneumatic regulator of claim 1, wherein the inlet seat element is fixedly positioned between a shoulder of the body and a threaded insert, such that an outer surface of the inlet seat element abuts the shoulder of the body, and the threaded insert forces the inlet seat element against the shoulder.

13. The balanced pneumatic regulator of claim 1, wherein the inlet seat element includes a conduit extending through the inlet seat element from an upstream end of the inlet seat element to a downstream end of the inlet seat element.

14. The balanced pneumatic regulator of claim 13, wherein the conduit of the inlet seat element fluidly couples the fluid inlet to the internal pressure chamber of the piston.

15. The balanced pneumatic regulator of claim 1, wherein the spring is positioned within the body, and wherein the spring is axially aligned with and surrounds at least a portion of the piston.

16. The balanced pneumatic regulator of claim 15, wherein the spring comprises a plurality of disc springs.

17. The balanced pneumatic regulator of claim 15, wherein the spring is configured to induce a force on the piston to cause the piston to translate away from the fluid inlet and towards the regulated-pressure fluid outlet, opening connection from the fluid inlet to the regulated-pressure fluid outlet through the at least one channel.

18. The balanced pneumatic regulator of claim 1, wherein when the piston is in the second axial position, a fluid flowing from the fluid inlet produces a force that causes the piston plunger to bias the piston toward the first axial position to at least partially offset a force acting upon the seat element of the piston.

19. The balanced pneumatic regulator of claim 1 and further comprising:
at least one seal positioned between the piston and the body; and
at least one seal positioned between a piston plunger and the piston.

20. The balanced pneumatic regulator of claim 1, wherein the balanced pneumatic regulator is configured for use with a pneumatic projectile launching device.

21. A balanced pneumatic regulator comprising:
a body including a central axis that extends through the body;
an inlet seat element within the body, the inlet seat element is fluidly coupled to a fluid inlet through a conduit;
a piston positioned within the body downstream of the inlet seat element, the piston being configured to translate axially along the central axis within the body between first and second axial positions, the piston including:
an upstream end with a seat element that is adapted to seal against the inlet seat element in the first axial position,
a passageway located within the seat element that extends to an internal pressure chamber,
at least one channel that extends between the upstream end of the piston and a downstream end of the piston, the at least one channel is located in an area outside of the seat element; and
a piston plunger extending axially away from a downstream end of the piston, the piston plunger including a pressure passage extending through the piston plunger and fluidly coupling the passageway to a pressure chamber separate from the piston,
a spring that biases the piston toward the second axial position; and
a regulated-pressure fluid outlet positioned downstream of the piston;
wherein, upon a force of the spring exceeding a force generated by a fluid pressure at the downstream end of the piston, the piston is configured to translate axially toward the second axial position opening the at least one channel in the piston such that fluid from the fluid inlet travels toward the regulated-pressure fluid outlet, and a pressure on the upstream end of the piston is at least partially equalized by a pressure on a downstream end of the piston plunger within the pressure chamber.
